(19) United States
(12) Patent Application Publication
(10) Pub. No.: US 2003/0030273 A1
(43) Pub. Date: Feb. 13, 2003

(54) Elastic shaft coupling

(76) Inventors: Masahiro Shimizu, Kasugai-shi (JP); Atsunori Tatematsu, Anjo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/214,125

(22) Filed: Aug. 8, 2002

(30) Foreign Application Priority Data
Aug. 10, 2001 (JP) 2001-244239

(51) Int. Cl. F16L 39/00

(52) U.S. Cl. 285/124.3

(57) ABSTRACT

An elastic shaft coupling employed, for example, in a joint mounted between a steering column and a steering gear in a steering apparatus for automobiles includes a generally disk-like body made from rubber, a first through hole formed through the body so that a first shaft is inserted through it, a second through hole formed through the body so that a second shaft is inserted through it, and a reinforcement made from a metal and embedded in the body, the reinforcement having a plurality of support portions disposed so as to surround the first and second holes and spring portions formed between the support portions.

### BACKGROUND OF THE INVENTION

1. Field of the Invention

This invention relates to an elastic shaft coupling employed, for example, in a joint provided between a steering column and a steering gear in a steering apparatus for automobiles.

2. Description of the Related Art

A joint is provided for transmission of a steering force between a steering column and a steering gear in a steering apparatus of an automobile. An elastic shaft coupling is provided in the joint for transmitting torque and for limiting or reducing oscillation or vibration transmitted from an automobile body to a driver.

FIG. 14 illustrates a conventionally used elastic shaft coupling of the type described above. The shown elastic shaft coupling includes a pair of disks 100 made of rubber. Each disk 100 has two first through holes 101 at a driving side and two second through holes 102 at a driven side. The first and second holes 101 and 102 are arranged circumferentially alternately so as to be circumferentially symmetric about a central through hole through which a connecting bolt is inserted. Two driving shafts and two driven shafts (not shown) are inserted through the holes 101 and 102 respectively. Reinforcements 103 are interposed between the disks 100 to be joined together. Each reinforcement 103 comprises a thread made from an organic fiber such as polyester, nylon, etc. The thread is formed into a number of rings each disposed around two adjoining first and second holes 101 and 102. The reinforcements 103 increase a torsional rigidity of the elastic shaft coupling.

The above-described elastic shaft coupling is manufactured as follows. Firstly, a pair of rubber disk sheets each made from unvulcanized rubber are prepared. Each rubber sheet has a smaller outer diameter than each completed disk 100. Four reinforcements 103 are prepared. A vertically separable molding die is prepared. One of the rubber sheets is placed in a lower die and the reinforcements 103 are placed on the rubber sheet so as to each surround two adjoining holes 101 and 102. The other rubber sheet is then placed on the reinforcements 103 and an upper die is attached to the lower die so that the rubber sheets are pressurized. Heat is applied to the molding die so that a product is formed.

A number of reinforcements 103 or thread rings are wound so as to be placed one upon another into an initial state of the product. However, the reinforcements 103 cannot be maintained in their initial state for the following reasons. Firstly, as shown in FIG. 14, a desired torsional rigidity cannot be achieved when the reinforcements are not placed one upon another in a direction of the thickness. However, placing the reinforcements one upon another tends to result in an unevenness in the thickness of the winding. Secondly, since the reinforcement comprises a thread made from an organic fiber, vulcanization results in heat shrinkage in the reinforcement. Thirdly, a vulcanizing pressure applied to the rubber disarranges the thread rings.

When the reinforcements 103 differ in the form thereof from product to product, the torsional characteristics of the elastic shaft coupling also vary from one product to another.

### SUMMARY OF THE INVENTION

Therefore, an object of the present invention is to provide an elastic shaft coupling which can exhibit stable torsional characteristics.

The present invention provides an elastic shaft coupling comprising a generally disk-like body made from rubber, a first through hole formed through the body so that a first shaft is inserted therethrough, a second through hole formed through the body so that a second shaft is inserted therethrough, and a reinforcement made from a metal and embedded in the body, the reinforcement having a plurality of support portions disposed so as to surround the first and second holes and spring portions formed between the support portions.

The metal reinforcement, from which a larger torsional rigidity can be obtained than from the previously used organic fiber, is interposed between the first and second holes. Accordingly, disarrangement of the reinforcement subjected to thermal effect or vulcanizing pressure of the rubber during the molding is prevented. Consequently, variations in the torsional characteristics can be reduced. Furthermore, since the reinforcement is provided with the support portions and spring portions, desired torsional characteristics can be achieved more easily as compared with the organic fiber.

### BRIEF DESCRIPTION OF THE DRAWINGS

Other objects, features and advantages of the present invention will become clear upon reviewing of the following detailed description, made with reference to the accompanying drawings, in which:

FIG. 1 is a perspective view of an elastic shaft coupling of a first embodiment in accordance with the present invention;

FIG. 2 is a perspective view of a reinforcement employed in the elastic shaft coupling;

FIG. 3 is a top plan view of the elastic shaft coupling;

FIG. 4 is a sectional view of upper and lower dies used for molding the elastic shaft coupling;

FIG. 5 is a perspective view of a reinforcement used in the elastic shaft coupling of a second embodiment in accordance with the present invention;

FIG. 6 is a top plan view of the elastic shaft coupling;

FIG. 7 is a top plan view of a reinforcement used in the elastic shaft coupling of a third embodiment in accordance with the present invention;

FIG. 8 is a top plan view of a reinforcement used in the elastic shaft coupling of a fourth embodiment in accordance with the present invention;

FIG. 9 is a top plan view of a reinforcement used in the elastic shaft coupling of a fifth embodiment in accordance with the present invention;

FIG. 10 is a perspective view of a reinforcement used in the elastic shaft coupling of a sixth embodiment in accordance with the present invention;

FIG. 11 is a top plan view of a reinforcement used in the elastic shaft coupling of a seventh embodiment in accordance with the present invention;

FIG. 12 is a side view of the reinforcement;

FIG. 13 is a top plan view of a reinforcement used in the elastic shaft coupling of an eighth embodiment in accordance with the present invention; and

FIG. 14 is an exploded perspective view of a conventional elastic shaft coupling.

### DETAILED DESCRIPTION OF THE INVENTION

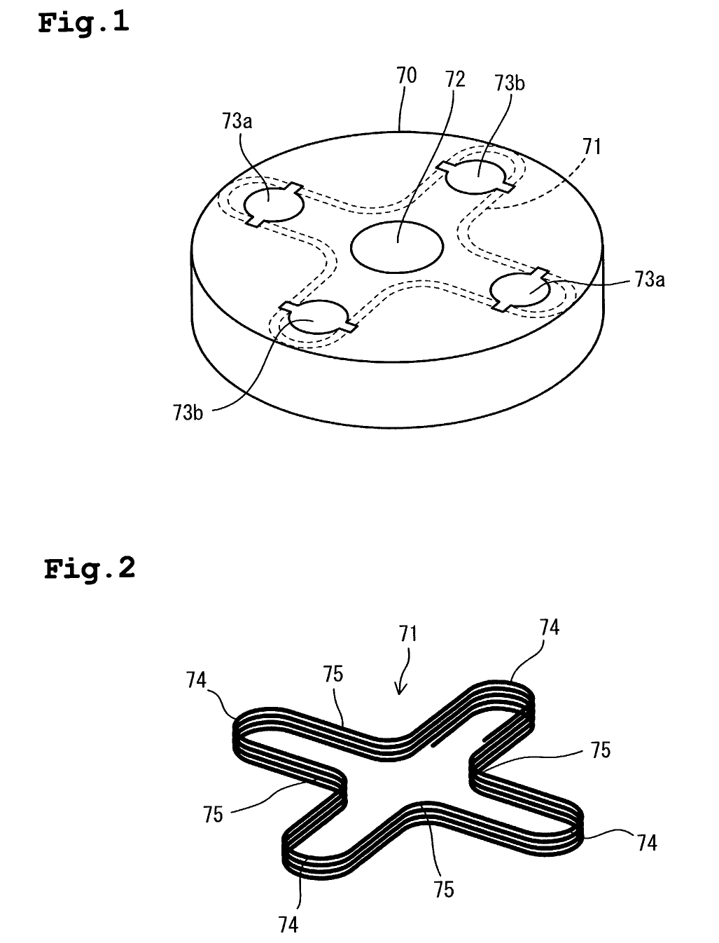

A first embodiment of the present invention will be described with reference to FIGS. 1 to 4. In the first embodiment, the elastic shaft coupling of the invention is used in a steering mechanism of an automobile. The elastic shaft coupling includes a solid body 70 made from rubber and reinforcements 71 each of which is made from a metal exhibiting a spring force and embedded in the body 70.

The body 70 of the elastic shaft coupling will first be described in detail. The body 70 is generally disk-like and has a central through hole 72 through which a connecting bolt (not shown) is inserted. The body 70 further has four through holes 73a and 73b arranged along a circumference of the body at intervals of 90° with respect to the center of the body. The holes 73a and 73b have the same diameter. The paired holes 73a are arranged symmetrically about a central axis of the body 70. The paired holes 73b are also arranged symmetrically about the central axis of the body 70. The paired holes 73a are driving side through holes through which two steering column side shafts (not shown) serving as a first shaft in the invention are adapted to be inserted. The paired holes 73b are driven side through holes through which two steering gear side shafts (not shown) serving as a second shaft in the invention are adapted to be inserted.

The reinforcement 71 is formed by bending a metal exhibiting a spring force, for example, a piano wire, alloy steel or the like. The reinforcement 71 preferably has a diameter not exceeding 6 mm in view of the forming efficiency but not less than 0.4 mm in view of desired torsional characteristics and strength. The reinforcement 71 generally has the shape of a cross and is closely wound into four stages. The number of stages may be one or more. More specifically, each stage of the reinforcement 71 includes four support portions 74 extending along outer circumferential portions of the holes 73a and 73b toward the central hole 72 respectively and four generally arc-shaped spring portions 75 connecting proximal ends of adjoining support portions at an outer circumference of the central hole 72 respectively. Each spring portion 75 is allowed to be elastically deformed so that the curvature of the arc-shaped portion is increased or reduced when the distal end side of each support portion is subjected to a torsional torque. Thus, an elastic deformation of the reinforcement 71 is allowed such that the adjacent support portions 74 are caused to come close to and to depart from each other.

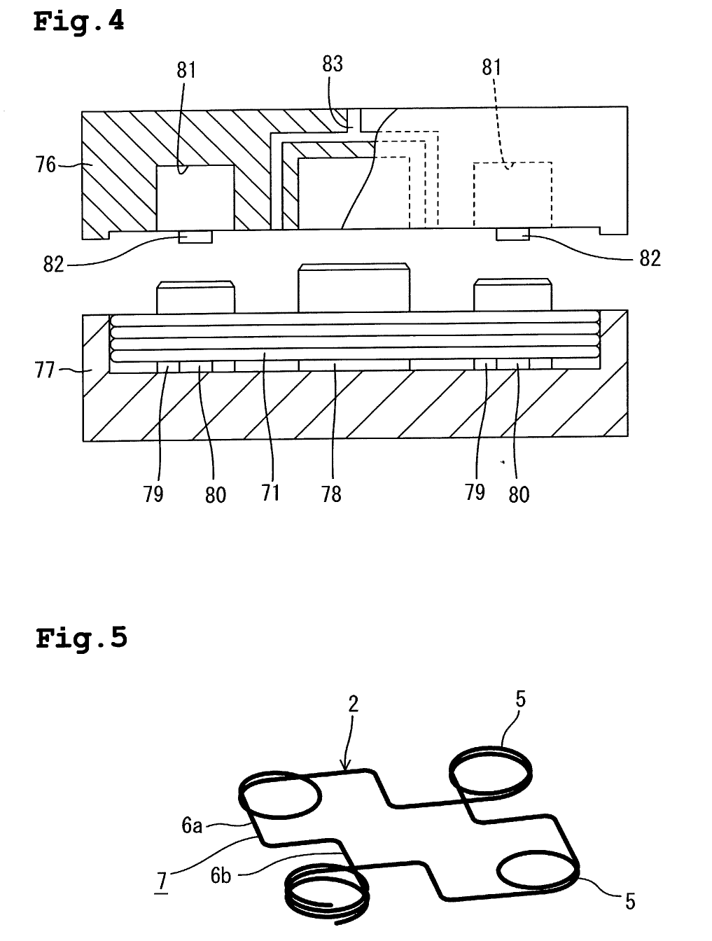

A method of manufacturing the foregoing elastic shaft coupling will now be described. Firstly, the reinforcement 71 is set in a lower die 77 to which an upper die 76 is to be attached, as shown in FIG. 4. The lower die 77 has a bottom from which a center pin 78 protrudes. Four molding pins 79 serving to form the through holes 73a and 73b also protrude from the bottom of the lower die 77 so as to surround the center pin 78. Each molding pin 79 has a pair of positioning pins 80 protruding horizontally outwardly from it. The reinforcement 71 is firstly placed on the positioning pins 80 to be positioned so as to be spaced from the bottom of the lower die 77. On the other hand, the upper die 76 has five recesses 81 formed to correspond to the center pin 78 and molding pins 79 respectively upon die-closing. Furthermore, each of the recesses 81 corresponding to the respective molding pins 79 has an open edge formed with a positioning pin 82 corresponding to the positioning pin 80 at the lower die side 77, so that the reinforcement 71 is held between the lower and upper positioning pins 80 and 82 in a positioned state upon die-closing.

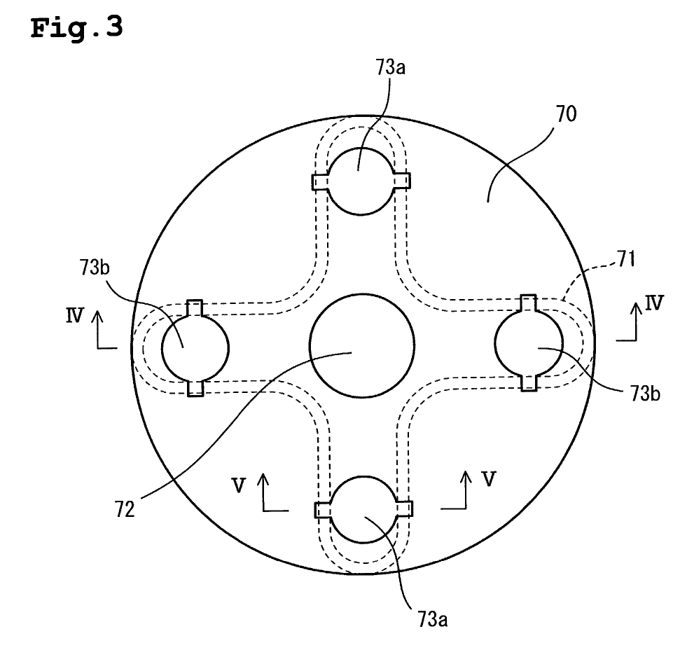

When molten rubber is then injected through a rubber supply passage 83 at the upper die 76 side into a cavity defined between the upper and lower dies 76 and 77, the body 70 is formed with the reinforcement 71 inserted therein. When the dies are opened after the rubber has been cooled to be solidified, the body having a predetermined shape is obtained with the reinforcement 71 being embedded therein. The reinforcement 71 is covered with rubber except for portions thereof in contact with the positioning pins 80 and 82, as shown in FIG. 3.

The operation of the elastic shaft coupling will now be described. When the steering of the automobile is operated such that the shafts (not shown) at the steering column side are displaced, the resultant torsional torque is transmitted via the body 70 and the reinforcement 71 to the shafts (not shown) at the steering gear side.

The following effects can be achieved from the foregoing elastic shaft coupling. The reinforcement 71 is formed from a single metal member. Consequently, the elastic shaft coupling with higher rigidity can be obtained as compared with the case where the conventional organic fiber is used as the reinforcement. Furthermore, the reinforcement 71 has no problem of heat shrinkage nor of deformation due to an injection pressure during the molding. Consequently, the torsional characteristics of the elastic shaft coupling can be stabilized.

A pair of disks each formed from an unvulcanized rubber are conventionally pressed and heated with a reinforcement being interposed between the disks. In the foregoing embodiment, however, the elastic shaft coupling can be formed by the injection molding. Consequently, a forming time in the embodiment can be reduced as compared with the conventional method and accordingly, the manufacturing cost can be reduced. Furthermore, since the shape stability of the reinforcement 71 is improved, the reinforcement can easily be set in the molding die. This can further reduce the forming time with further reduction in the manufacturing cost. Additionally, when the reinforcement 71 is formed into a plurality of stages, the torsional rigidity of the reinforcement can easily be adjusted by setting the number of stages thereof.

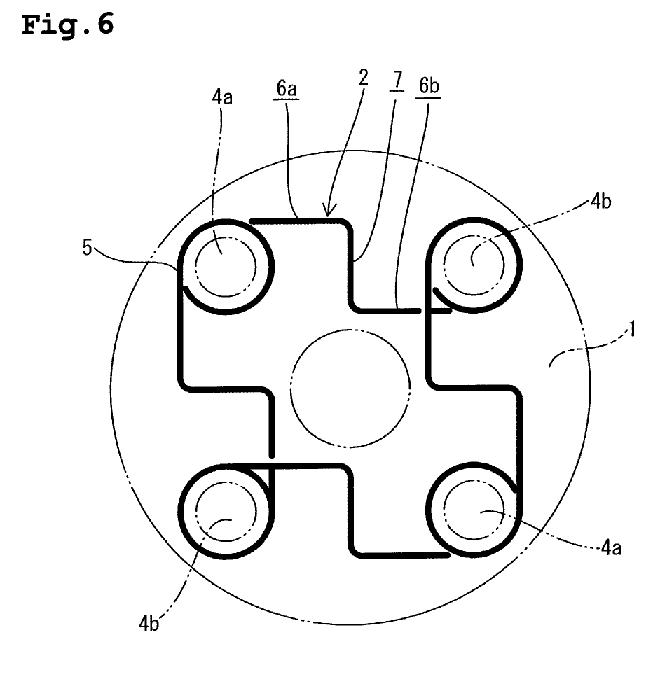

FIGS. 5 and 6 illustrate a second embodiment of the invention. The second embodiment differs from the foregoing embodiment in the construction of the reinforcement. The reinforcement 2 employed in the elastic shaft coupling of the second embodiment is also formed by bending a single metal material. The reinforcement 2 has four support portions 5 located to correspond to the through holes 4a and 4b respectively. Each support portion 5 is generally formed into the shape of a circle having a slightly larger diameter than the corresponding hole 4a or 4b. Each support portion 5 is wound so as to surround the corresponding hole 4a or 4b. The winding starts at any one of the four support portions 5, sequentially advancing to the neighboring support portions 5. The winding ends with the support portion 5 at which the winding starts.

A portion of the metal between each support portion 5 and the neighboring one includes two parallel parts 6a and 6b extending tangentially from circularly bent portions along the circumferences of the holes 4a and 4b respectively. The parallel parts 6a and 6b are located at different levels. A part of the parallel parts 6a and 6b serves as a spring portion 7. The spring portion 7 is generally at a right angle to each of the parallel parts 6a and 6b. When a generally axial torsional torque acts on the support portions 5, the spring portions 7 allow deformation of the support portions 5.

The method of making the body 1 is substantially the same as described in the first embodiment and the construction of the body 1 is substantially the same as that in the first embodiment. Accordingly, the description of the body 1 will be eliminated in the second embodiment. The same effect can be achieved from the second embodiment as from the first embodiment.

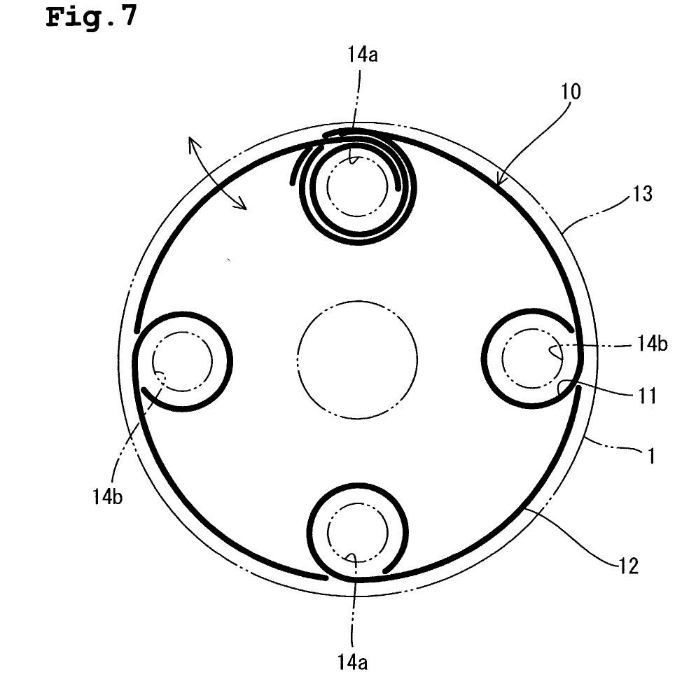

FIG. 7 illustrates a third embodiment of the invention. The reinforcement 10 employed in the elastic shaft coupling of the third embodiment is also formed by bending the single metal in the same manner as those in the first and second embodiments. Each support portion is formed by bending the metal into a circular shape surrounding the hole 14a or 14b. The winding starts at any one of the four support portions 11, sequentially advancing to the neighboring support portions 11. The winding ends with the support portion 11 at which the winding starts.

A portion of the metal between each support portion 11 and the neighboring one serves as a generally arc-shaped spring portion 12 extending along the circumferential edge of the body 1. A torsional torque acting between each hole 14a and neighboring hole 14b results in a deformation causing outward expansion or tension causing deformation into a linear shape.

The other construction of the elastic shaft coupling of the third embodiment is substantially the same as described in the first or second embodiment. Accordingly, the same effect can be achieved from the third embodiment as from the first embodiment.

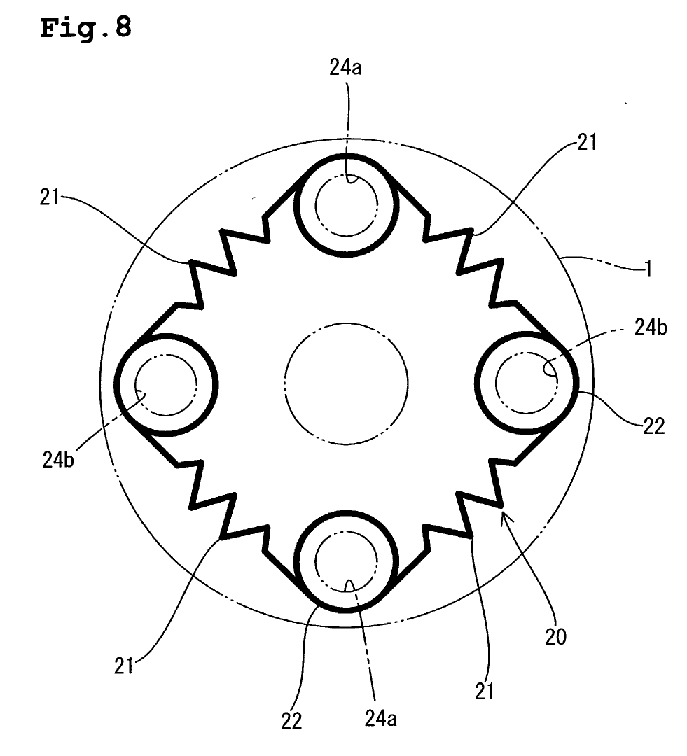

FIG. 8 illustrates a fourth embodiment of the invention. The reinforcement 20 includes four support portions 22 each of which extends substantially overall circumference of the corresponding through hole 24a or 24b of the body 1. A portion of the reinforcement 20 between each support portion 22 and the neighboring one extends tangentially toward the neighboring hole 24a or 24b. Each portion includes a helically wound spring portion 21. Accordingly, each spring portion 21 is deformed to be expanded and contracted tangentially. Thus, each spring portion 21 is formed into a coil spring in the embodiment.

The other construction of the elastic shaft coupling of the fourth embodiment is substantially the same as described in the foregoing embodiments. Accordingly, the same effect can be achieved from the fourth embodiment as from the first embodiment.

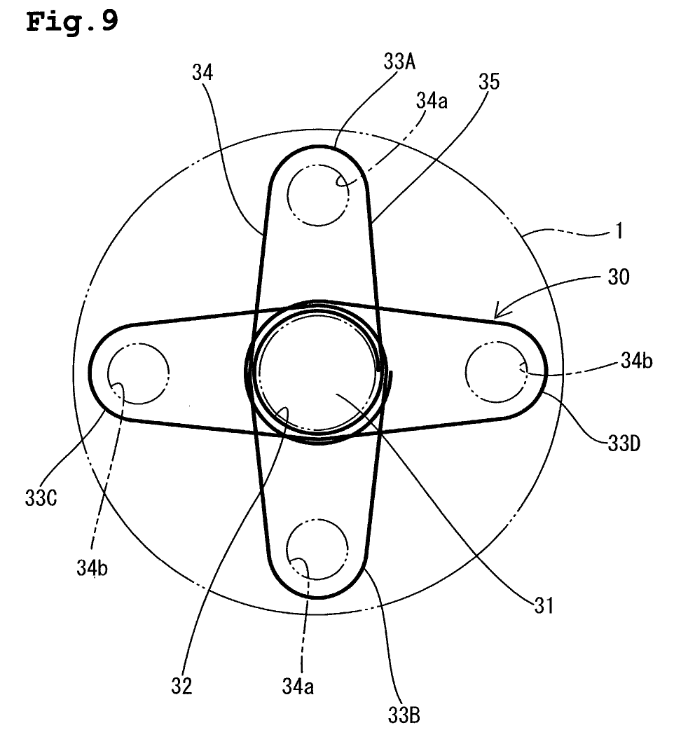

FIG. 9 illustrates a fifth embodiment of the invention. The reinforcement 30 employed in the elastic shaft coupling of the fifth embodiment includes a fixing portion 32 surrounding the central hole 31 of the body 1. The fixing portion 32 serves as a starting end of the metal. After making a round of the central hole 31, the reinforcement 30 extends toward the upper hole 34a as viewed in FIG. 9. The reinforcement 30 is then bent along the circumference of the hole 34a generally into a U-shape, thereby forming a support portion 33A. The reinforcement 30 is further caused to return to the fixing portion 32. The reinforcement 30 is further caused to extend toward the lower hole 34a as viewed in FIG. 9. The reinforcement 30 is bent along the circumference of the hole 34a generally into a U-shape in the same manner as described above, thereby forming a support portion 33B. The reinforcement 30 is caused to return to the fixing portion 32 again and directed to the left-hand hole 34b as viewed in FIG. 9. After a support portion 33C has been formed around the hole 34b, the reinforcement 30 is directed to the right-hand hole 34b so that a support portion 33D is formed. The reinforcement 30 is then caused to return to the fixing portion 32.

Each support portion is formed without extending along the overall circumference of the hole 34a or 34b in the fifth embodiment. Linear portions 35 of the metal extending from both ends of each support portion 33A to 33D and the fixing portion 32 constitute a spring portion. The other construction of the elastic shaft coupling of the fifth embodiment is substantially the same as described in the foregoing embodiments. Accordingly, the same effect can be achieved from the fifth embodiment as from the first embodiment.

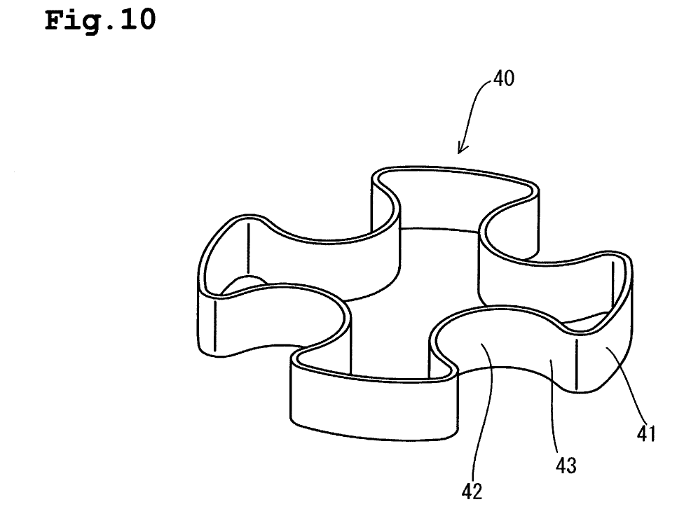

FIG. 10 illustrates a sixth embodiment of the invention. The reinforcement is formed by bending a single metal material in each of the foregoing embodiments. In the sixth embodiment, the reinforcement is formed by pressing a metal plate (for example, carbon steel strip for spring or cold rolled steel strip). The reinforcement 40 as shown in FIG. 10 is formed by bending a generally annular material with a predetermined width into a predetermined shape. The material includes portions of the circumferential edge thereof corresponding to the through holes of the body. Each of these portions is recessed inward into a generally semicircular shape, thereby serving as a support portion 42.

The reinforcement 40 further includes four generally arc-shaped protrusions 41 connecting between each support portion 42 and the neighboring one. A portion between the protrusion 41 and the support portion 42 serves as a spring portion 43. The reinforcement 40 is allowed to be elastically deformed so that each support portion 42 comes close to or is departed from each neighboring one. A plurality of independent pieces may be combined together by welding though the reinforcement 40 can be integrally formed.

The same effect can be achieved from the sixth embodiment as from each of the foregoing embodiments. Furthermore, the reinforcement 40 is made of a metal plate but not of a wire. Accordingly, a higher torsional rigidity can be obtained from the elastic shaft coupling of the sixth embodiment than those of the foregoing embodiments in each of which the reinforcement is made of the wire.

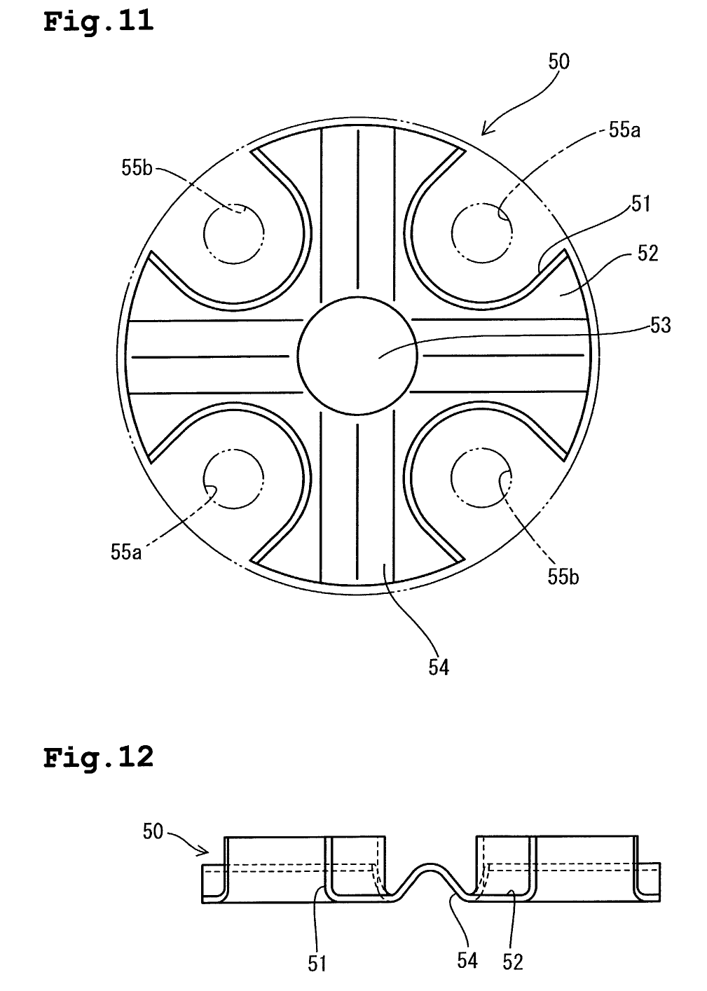

FIGS. 11 and 12 illustrate a seventh embodiment of the invention. The reinforcement 50 of the elastic shaft coupling of the seventh embodiment is formed by pressing a generally circular metal plate at a plurality of times. The reinforcement 50 has a center hole 53 formed therethrough so as to correspond to the central hole (not shown) of the body.

The reinforcement 50 includes four support portions 51 formed there on so as to correspond to the holes 55a and 55b respectively. Each support portion 51 is curved toward the center hole 53. Each support portion 51 has a wall face 54 standing generally at a right angle from the bottom 52. The reinforcement 50 has four spring portions 54 formed between the support portions 51. Each spring portion 54 extends radially outward from the center hole 53. Each spring portion 54 is expanded at the surface side and generally has a conical shape with an arc-shaped top. Each support portion 51 exerts a spring force causing the support portions 51 to come close to and be departed from each other with the curvature of each support portion being maintained when the torsional torque acts on the reinforcement 50. The other construction of the elastic shaft coupling of the seventh embodiment is substantially the same as described in the sixth embodiment. Accordingly, the same effect can be achieved from the seventh embodiment as from the sixth embodiment.

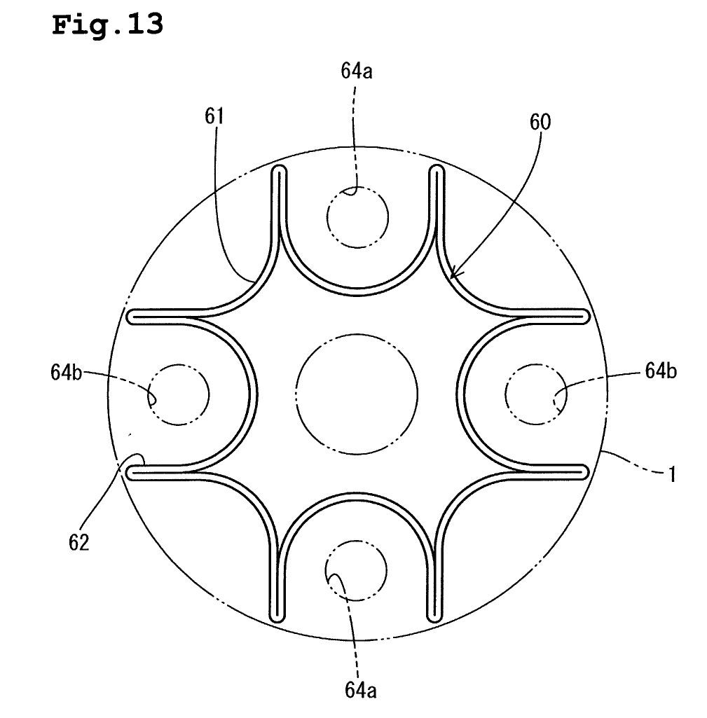

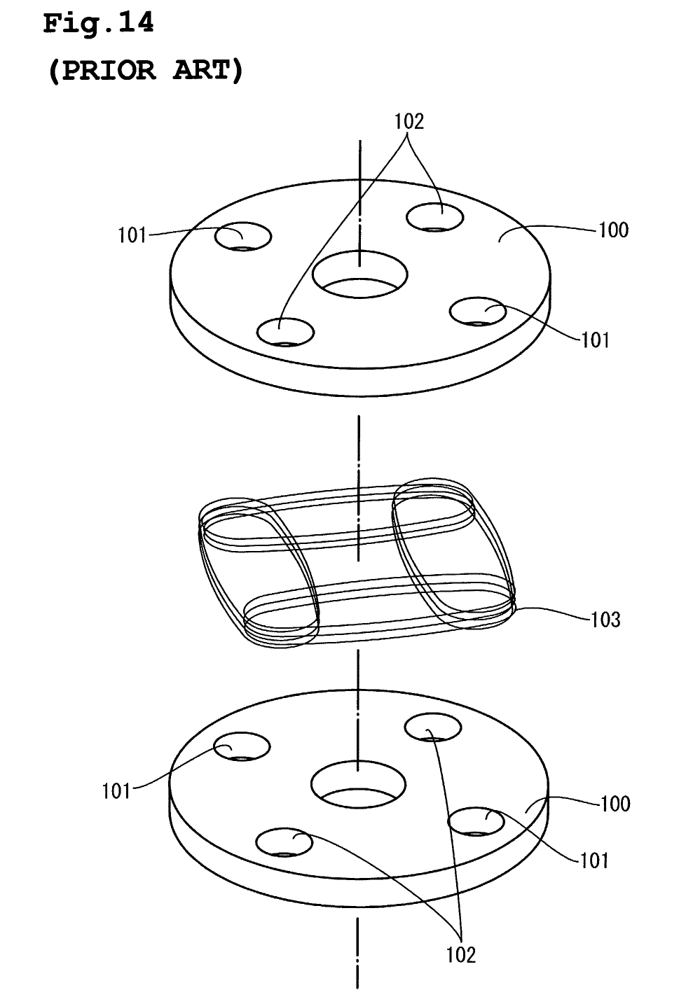

FIG. 13 illustrates an eighth embodiment of the invention. The reinforcement 60 is formed by bending a generally annular metal plate into a predetermined shape in the same manner as in the sixth embodiment. The reinforcement 60 has four support portions 62 formed to surround the holes 64a and 64b of the body 1 respectively. In the above-described sixth embodiment, the reinforcement 40 includes the outwardly convex arc-shaped protrusions 41 connecting between each support portion 42 and the neighboring one. In the eighth embodiment, on the other hand, an opening side edge of each support portion 62 is folded back such that an inwardly convex arc-shaped portion connects between each support portion and the neighboring one thereby to serve as a spring portion 61. The other construction of the elastic shaft coupling of the eighth embodiment is substantially the same as described in the sixth embodiment. Accordingly, the same effect can be achieved from the eighth embodiment as from the sixth embodiment.

The elastic shaft coupling of the invention is incorporated in the steering mechanism in the foregoing embodiments. However, the elastic shaft coupling may be used in other torque-transfers.

The elastic shaft coupling has two driving side holes and two driven side holes in each of the foregoing embodiments. However, the numbers of these holes should not be limited.

The reinforcement is a single member in each of the foregoing embodiments. However, the reinforcement may be divided into four parts each extending between adjoining holes, instead.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

We claim:

1. An elastic shaft coupling comprising:
a generally disk-like body made from rubber;
a first through hole formed through the body so that a first shaft is inserted therethrough;
a second through hole formed through the body so that a second shaft is inserted therethrough; and
a reinforcement made from a metal and embedded in the body, the reinforcement having a plurality of support portions disposed so as to surround the first and second holes and spring portions formed between the support portions.

2. An elastic shaft coupling according to claim 1, wherein the body has a plurality of the first holes arranged along a circumference thereof symmetrically about a central axis thereof, and the body also has a plurality of the second holes whose number is equal to a number of the first holes, the second holes being arranged along the circumference thereof so that the first and second holes are disposed alternately at regular intervals.

3. An elastic shaft coupling according to claim 1, wherein the reinforcement is made of a metal wire so that both of the support and spring portions thereof are formed by bending the metal wire.

4. An elastic shaft coupling according to claim 2, wherein the reinforcement is made of a metal wire so that both of the support and spring portions thereof are formed by bending the metal wire.

5. An elastic shaft coupling according to claim 1, wherein the reinforcement is made of a metal plate so that both of the support and spring portions thereof are formed by bending the metal plate.

6. An elastic shaft coupling according to claim 1, wherein the reinforcement is formed from a single material having the support portions corresponding to the first and second holes.

7. An elastic shaft coupling according to claim 4, wherein the reinforcement is formed from a single material having the support portions corresponding to the first and second holes.

8. An elastic shaft coupling according to claim 1, wherein each spring or support portion is formed by winding a single wire so that turns of the wire are laid one upon another in a direction of a height thereof.

9. An elastic shaft coupling according to claim 7, wherein each spring or support portion is formed by winding a single wire so that turns of the wire are laid one upon another in a direction of a height thereof.

10. An elastic shaft coupling according to claim 1, wherein the body is formed by an injection molding with the reinforcement being disposed in a molding die.

11. An elastic shaft coupling according to claim 9, wherein the body is formed by an injection molding with the reinforcement being disposed in a molding die.
